(19) United States
(12) Patent Application Publication
(10) Pub. No.: US 2021/0181611 A1
(43) Pub. Date: Jun. 17, 2021

(54) HANDHELD GIMBAL

(71) Applicant: SZ DJI TECHNOLOGY CO., LTD., Shenzhen (CN)

(72) Inventor: Tianhang MA, Shenzhen (CN)

(73) Assignee: SZ DJI TECHNOLOGY CO., LTD., Shenzhen (CN)

(21) Appl. No.: 17/184,595

(22) Filed: Feb. 25, 2021

Related U.S. Application Data
(63) Continuation of application No. PCT/CN2018/106534, filed on Sep. 19, 2018.

(51) Int. Cl. G03B 17/56; F16M 11/12; F16M 13/04

(52) U.S. Cl. CPC G03B 17/561; F16M 13/04; F16M 11/123

(57) ABSTRACT

The present disclosure provides a handheld gimbal, including a handle and a photographing apparatus (mounted on the handle. The handle is provided with a first electrical contact portion. An end portion of the handle is rotatably provided with an adapter ring. The adapter ring is provided with a first connecting member. The photographing apparatus is provided with a second connecting member engaged with the first connecting member and a second electrical contact portion electrically connected to the first electrical contact portion. The adapter ring rotates in a first direction, so that the first connecting member and the second connecting member are locked to each other. The adapter ring rotates in a direction opposite to the first direction, so that the first connecting member and the second connecting member are unlocked from each other. This ensures a mechanical connection between the handle and the photographing apparatus, and facilitates the detachment.

### RELATED APPLICATIONS

This application is a continuation application of PCT application No. PCT/CN2018/106534, filed on Sep. 19, 2018, and the content of which is incorporated herein by reference in its entirety.

### TECHNICAL FIELD

Embodiments of the present disclosure relate to the field of gimbal technologies, and in particular, to a handheld gimbal.

### BACKGROUND

With increasingly higher requirements for video photographing, users have growing demands for gimbals. Handheld gimbals have become the products commonly used by many users. As carriers of electronic devices (such as mobile phones or cameras), the handheld gimbals can provide stable photographing conditions for the electronic devices. As gimbal technologies develop, the handheld gimbals have become smaller, so that users no longer need to carry bulky three-axis devices to achieve the effect of gimbal photographing.

However, small handheld gimbals usually aim at an integrated design and do not have a quick release function for gimbal cameras and handles. Thus, it is usually difficult to separate a gimbal camera from a photographing handle. As a result, small handheld gimbals are portable for users due to integrated designs, but cannot provide targeted protection and storage for the gimbals and handles, and the gimbal cameras cannot be separately upgraded in the future.

### BRIEF SUMMARY

Embodiments of the present disclosure provide a portable handheld gimbal.

Specifically, the embodiments of the present disclosure are implemented by using the following technical solution:

A handheld gimbal, including: a handle including: a first electrical contact portion, and an adapter ring rotatably disposed on an end portion of the handle, the adapter ring including a first connecting member; and a photographing apparatus mounted on the handle and including: a second connecting member detachably connect to the first connecting member, and a second electrical contact portion electrically connect to the first electrical contact portion, wherein rotating the adapter ring in a first direction locks the first connecting member with the second connecting member, and rotating the adapter ring in a direction opposite to the first direction unlocks the first connecting member from the second connecting member, a mounting portion to engage with the adapter ring, and both the second connecting member and the second electrical contact portion being disposed on the mounting portion, and wherein one of the first connecting member and the second connecting member is a clamping slot, and the other one of the first connecting member and the second connecting member is a clamping jaw adapted to the clamping slot.

It can be learned from the foregoing technical solutions that, in the handheld gimbal provided by the present disclosure, a first connecting member and a second connecting member that may be detached from each other are disposed on a handle and a photographing apparatus, and a first electrical contact portion and a second electrical contact portion may be electrically connected when the first connecting member and the second connecting member are connected and fixed to each other, so that the handle and the photographing apparatus are electrically connected to each other, thereby implementing signal transmission between the handle and the photographing apparatus. The connection between the first connecting member and the second connecting member ensures a mechanical connection between the handle and the photographing apparatus and facilitate detachment, thereby making the handheld gimbal easy to carry and store.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some exemplary embodiments of the present disclosure, and a person of ordinary skill in the art may still derive other drawings from these accompanying drawings without creative efforts.

FIG. 1 is a perspective schematic view of a handheld gimbal according to some exemplary embodiments of the present disclosure;

FIG. 2 is another perspective schematic view of a handheld gimbal according to some exemplary embodiments of the present disclosure;

FIG. 3 is a front view of a handheld gimbal according to some exemplary embodiments of the present disclosure;

FIG. 4 is a schematic exploded view of a handle and a photographing apparatus of a handheld gimbal according to some exemplary embodiments of the present disclosure;

FIG. 5 is a perspective schematic view of a photographing apparatus of a handheld gimbal according to some exemplary embodiments of the present disclosure;

FIG. 6 is a top view of a handle of a handheld gimbal according to some exemplary embodiments of the present disclosure;

FIG. 7 is a bottom view of a photographing apparatus of a handheld gimbal according to some exemplary embodiments of the present disclosure;

FIG. 8 and FIG. 9 are each a schematic structural diagram of an adapter member of a handheld gimbal in a use manner according to some exemplary embodiments of the present disclosure;

FIG. 10 and FIG. 11 are each a schematic connection diagram of a handheld gimbal and a mobile device according to some exemplary embodiments of the present disclosure; and

FIG. 12 is a schematic structural diagram of an adapter member of a handheld gimbal in a use manner according to some exemplary embodiments of the present disclosure.

### REFERENCE NUMERALS

100—handheld gimbal; 10—handle; 11—accommodation slot; 111—first accommodation portion;
112—second accommodation portion; 12—electrical contact engagement portion; 13—first connecting member; 131—first clamping segment;
132—second clamping segment; 14—first electrical contact portion; 141—first metal contact; 15—adapter ring;
16—guide groove; 17—positioning pin; 20—photographing apparatus; 21—second connecting member; 211—body portion;
212—hook portion; 22—photographing element; 23—yaw shaft assembly; 24—roll shaft assembly; 25—pitch shaft assembly;
26—second electrical contact portion; 261—second metal contact; 27—mounting portion;
30—adapter member; 31—electrical contact portion;
32—adapter portion; 33—adapter head; 34—guide portion; 35—positioning slot; 36—electrical connection portion; 50—display screen;
60—control part; 61—shutter button; 62—power button; 70—card slot; 71—charging interface; 72—microphone;
73—indicator; 90—mobile device.

### DETAILED DESCRIPTION

The following describes the technical solutions in the embodiments of the present disclosure with reference to accompanying drawings of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the scope of protection of the present disclosure.

The following describes a handled gimbal according to the present disclosure in detail with reference to the accompanying drawings. If there is no conflict, the following embodiments and features may be combined with each other.

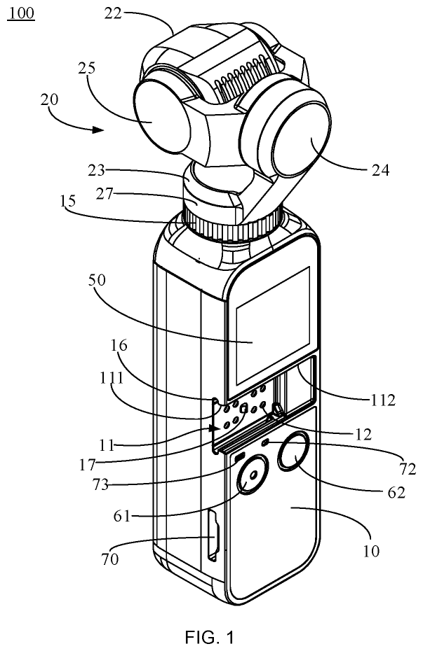

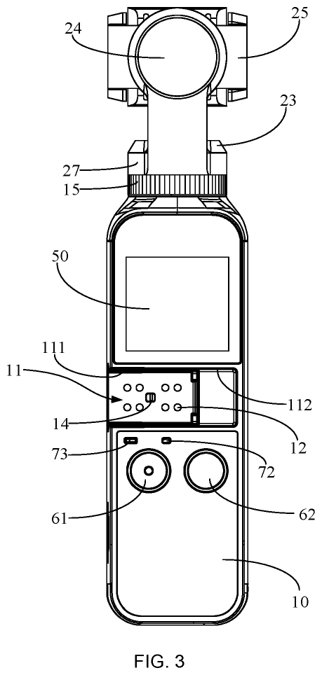

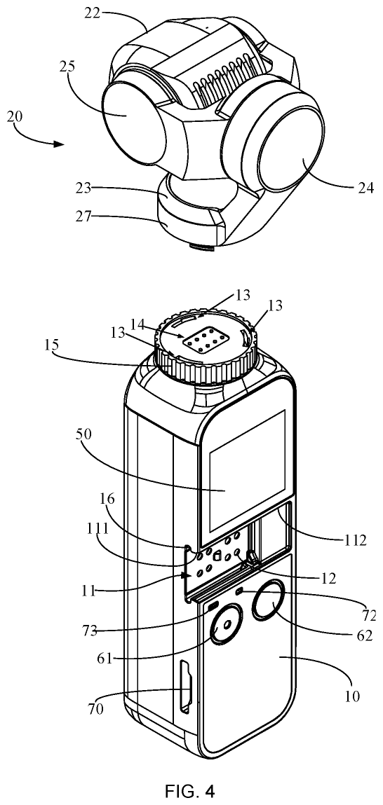

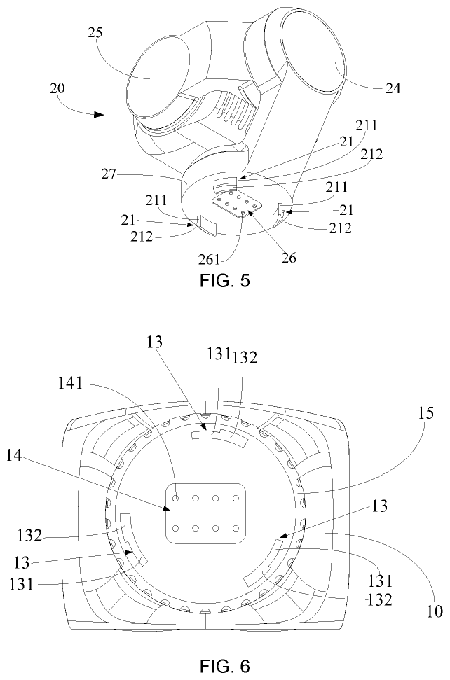

Referring to FIG. 1 to FIG. 5, some exemplary embodiments of the present disclosure provide a handheld gimbal 100, including a handle 10 and a photographing apparatus 20 mounted on the handle 10. A top surface of the handle 10 is provided with a first electrical contact portion 14. A top portion of the handle 10 is rotatably provided with an adapter ring 15. The adapter ring 15 is provided with a first connecting member 13. The photographing apparatus 20 is provided with a second connecting member 21 engaged with the first connecting member 13 and a second electrical contact portion 26 electrically connected to the first electrical contact portion 14. The electrical connection between the first electrical contact portion 14 of the handle 10 and the second electrical contact portion 26 of the photographing apparatus 20 enables the handle 10 and the photographing apparatus 20 to be electrically connected to each other, implement signal and data transmission between the handle 10 and the photographing apparatus 20, and enable a power supply of the handle 10 to supply power to the photographing apparatus 20. In some exemplary embodiments, the photographing apparatus 20 may include a three-axis gimbal camera.

The adapter ring 15 may rotate in a first direction, so that the first connecting member 13 of the handle 10 and the second connecting member 21 of the photographing apparatus 20 are locked to each other, thereby fixing the handle 10 and the photographing apparatus 20 to each other. The adapter ring 15 may also rotate in a direction opposite to the first direction, so that the first connecting member 13 of the handle 10 and the second connecting member 21 of the photographing apparatus 20 are unlocked from each other, thereby separating the handle 10 and the photographing apparatus 20 from each other.

It can be learned from the foregoing technical solutions that, in the handheld gimbal 100 of some exemplary embodiments of the present disclosure, the electrical connection between the first electrical contact portion 14 of the handle 10 and the second electrical contact portion 26 of the photographing apparatus 20 may implement signal and data transmission between the handle 10 and the photographing apparatus 20, and enable a power supply of the handle 10 to supply power to the photographing apparatus 20. The rotation of the adapter ring 15 may cause the first connecting member 13 of the handle 10 and the second connecting member 21 of the photographing apparatus 200 to be locked to or unlocked from each other, so that the handle 10 and the photographing apparatus 20 may be fixed to or detached from each other, thereby ensuring a mechanical connection between the handle 10 and the photographing apparatus 20, facilitating detachment, and making the handheld gimbal 100 easy to carry and store.

In some exemplary embodiments, the first connecting member 13 is disposed on an inner wall of the adapter ring 15, and the first electrical contact portion 14 is disposed on the top surface of the handle 10. The photographing apparatus 20 is provided with a mounting portion 27 engaged with the adapter ring 15, and both the second connecting member 21 and the second electrical contact portion 26 are disposed on the mounting portion 27. The rotation of the adapter ring 15 may enable the first connecting member 13 of the handle 10 and the second connecting member 21 of the photographing apparatus 20 to be locked to or unlocked from each other, so that the handle 10 and the photographing apparatus 20 can be fixed to or detached from each other. In some exemplary embodiments, the adapter ring 15 is disposed on the top portion of the handle 10, and the mounting portion 27 is disposed on a bottom portion of the photographing apparatus 20, so that the handle 10 and the photographing apparatus 20 may be connected to each other.

In some exemplary embodiments, one of the first connecting member 13 and the second connecting member 21 is a clamping slot, and the other one of the first connecting member 13 and the second connecting member 21 is a clamping jaw adapted to (such as matching) the clamping slot. It may be understood that, a detachable connection may be achieved through engagement between the clamping jaw and the clamping slot. When the clamping jaw is clamped in the clamping slot, the handle 10 and the photographing apparatus 20 are connected to each other. When the clamping jaw is taken out of the clamping slot, the handle 10 and the photographing apparatus 20 are separate from each other. In some practical applications, after the mounting portion 27 of the photographing apparatus 20 is mounted to the handle 10, rotation of the adapter ring 15 may lock the clamping slot and the clamping jaw to each other, and further fix the handle 10 and the photographing apparatus 20 to each other. Rotation of the adapter ring 15 in an opposite direction may unlock the clamping slot and the clamping jaw from each other, thereby separating the handle 10 and the photographing apparatus 20 from each other. Certainly, in other examples, the first connecting member 13 and the second connecting member 21 may alternatively be in other detachable structural forms, such as in magnetic attraction or threaded connection manner. This is not limited in the present disclosure.

In some exemplary embodiments, the first connecting member 13 is a clamping slot, and the second connecting member 21 is a clamping jaw. That is, the first connecting member 13 disposed on the adapter ring 15 of the handle 10 is a clamping slot, and the mounting portion 27 of the photographing apparatus 20 is provided with a clamping jaw engaged with the clamping slot. There may be a plurality of clamping slots that are evenly distributed on a top surface of the adapter ring 15 peripherally. The quality of the clamping jaws corresponds to the quality of the clamping slots, and the clamping jaws are evenly distributed on a periphery of the bottom surface of the mounting portion 27. In some exemplary embodiments, there are three clamping slots and three clamping jaws, and the clamping slots and the clamping jaws are evenly distributed peripherally.

In practical applications, a user may mount the mounting portion 27 of the photographing apparatus 20 to the adapter ring 15 of the handle 10. Through clamping engagement between the clamping jaws and the clamping slots, the handle 10 and the photographing apparatus 20 may be connected to each other. Taking the clamping jaws out of the clamping slots may separate the handle 10 and the photographing apparatus 20 from each other, thereby making the handheld gimbal 100 easy to carry and store.

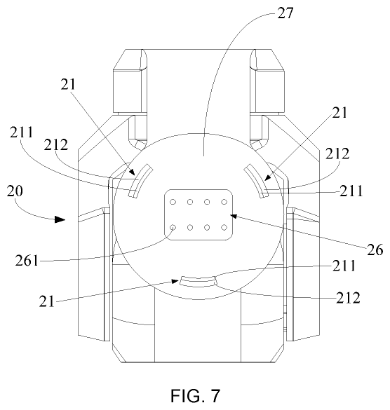

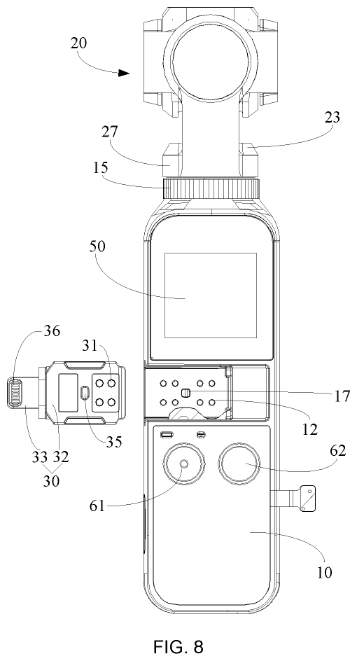

Referring to FIG. 6 and FIG. 7, in some exemplary embodiments, the clamping jaw may include a body portion 211 and a hook portion 212 that protrudes outward from the body portion 211. The clamping slot may include a first clamping segment 131 and a second clamping segment 132 communicating with the first clamping segment 131. A radial length of the first clamping segment 131 matches a radial length of the body portion 211, so that the body portion 211 of the clamping jaw may be clamped therein. A radial length of the second clamping segment 132 is not less than a sum of radial lengths of the body portion 211 and the hook portion 212, so that both the body portion 211 and the hook portion 212 of the clamping jaw may be clamped therein. In some exemplary embodiments, the hook portion 212 of the clamping jaw protrudes radially outward from the body portion 211, and correspondingly, the second clamping segment 132 of the clamping slot protrudes radially outward from the first clamping segment 131 to be engaged with the clamping jaw, so that the clamping jaw may be clamped therein.

In practical applications, when mounting the mounting portion 27 of the photographing apparatus 20 to the adapter ring 15 of the handle 10, a user may first insert the clamping jaw into the second clamping segment 132 of the clamping slot, and then rotates the clamping jaw in a direction approaching the first clamping segment 131 of the clamping slot, so that the body portion 211 of the clamping jaw is clamped in the hook portion 212 of the clamping slot. In this case, the hook portion 212 of the clamping jaw is hooked on an inner wall of the first clamping segment 131 of the clamping slot for positioning, thereby preventing the clamping jaw from falling out of the clamping slot. The clamping jaw may be elastic, or a thickness of the body portion 211 of the clamping jaw may be slightly greater than a width of the first clamping segment 131 of the clamping slot, so that when the clamping jaw rotates to be engaged with the clamping slot, there is a compression effect between the clamping jaw and the clamping slot, thereby making the clamping jaw and the clamping slot not move peripherally. When the handle 10 and the photographing apparatus 20 need to be detached from each other, only the body portion 211 of the clamping jaw needs to be rotated in a direction away from the first clamping segment 131 of the clamping slot until the body portion 211 of the clamping jaw is detached from the first clamping segment 131 of the clamping slot. In this case, both the body portion 211 and the hook portion 212 of the clamping jaw are located in the second clamping segment 132 of the clamping slot, and the hook portion 212 of the clamping jaw and the first clamping segment 131 of the clamping slot are separate from each other. In this way, the clamping jaw can be taken out of the clamping slot.

In some exemplary embodiments, the first electrical contact portion 14 includes a plurality of first metal contacts 141, and the second electrical contact portion 26 includes a plurality of second metal contacts 261 whose quantity corresponds to the quantity of the first metal contacts 141. The first electrical contact portion 14 disposed on the adapter member 15 and the second electrical contact portion 26 disposed on the mounting portion 27 are engaged to achieve electrical connection between the handle 10 and the photographing apparatus 20 via the contacts, and the process of implementing the electrical connection is simple and fast. It should be noted that, the quantity and distribution manner of the plurality of first metal contacts 141 of the first electrical contact portion 14 correspond to those of the plurality of second metal contacts 261 of the second electrical contact portion 26, so that after the photographing apparatus 20 is mounted on the adapter member 15 of the handle 10 via the second connecting member 21, the first electrical contact portion 14 and the second electrical contact portion 26 can be electrically connected to each other, thereby implementing the electrical connection between the handle 10 and the photographing apparatus 20. Certainly, in other examples, the first electrical contact portion 14 and the second electrical contact portion 26 may alternatively be electrically connected in other manners. For example, methods of telescopic probes, electrical plug-in interfaces, or direct surface-to-surface contact may be used to achieve electrical connection. This is not limited in the embodiments of the present disclosure.

In some exemplary embodiments, the handle 10 is provided with a display screen 50 for displaying the content photographed by the photographing apparatus 20. In some exemplary embodiments, the display screen 50 may be a touch liquid crystal display (LCD). Certainly, in other embodiments, other types of display screens may alternatively be used.

The display screen 50 is disposed on the handle 10 of the handheld gimbal 100, and the display screen can display the content photographed by the photographing apparatus 20, so that a user can quickly browse, through the display screen 50, pictures or videos captured by the photographing apparatus 20, thereby improving the experience and enjoyment of the user in interaction with the handheld gimbal 100, and meeting various user requirements.

In some exemplary embodiments, the handle 10 is further provided with a control part 60 for controlling the photographing apparatus 20. The control part 60 may be used to control the operation of the photographing apparatus 20, for example, control power on and power off of the photographing apparatus 20, control photographing of the photographing apparatus 20, and control the posture change of the gimbal of the photographing apparatus 20, so that a user can perform a quick operation on the photographing apparatus 20. The control part 60 may be in a form of a button (a virtual button or a physical button), a knob, or a joystick. In some exemplary embodiments, the control part 60 may include a shutter button 61 for controlling photographing of the photographing apparatus 20 and a power button 62 for controlling the power on and power off of the photographing apparatus 20. Certainly, the control part 60 may further include another control button, such as an image storage button or an image playing control button. This may be set as needed.

Further, the control part 60 and the display screen 50 may be disposed on a same side surface of the handle 10. The control part 60 and the display screen 50 shown in the figure are both disposed on a front surface of the handle 10. This is more in line with the usage habit of users, and is easier to operate. This makes the appearance and layout of the entire handheld gimbal 100 more appropriate and aesthetic.

In some exemplary embodiments, the handle 10 is further provided with a card slot 70 for inserting a storage device. In some exemplary embodiments, the card slot 70 is formed on a side surface of the handle 10 adjacent to the display screen 50. An SD card may be inserted into the card slot 70, so that an image captured by the photographing apparatus 20 may be stored in the SD card. In addition, disposing the card slot 70 on a side portion does not affect the use of other functions, thereby achieving better user experience.

In some exemplary embodiments, a battery for supplying power to the handle 10 and the photographing apparatus 20 may be provided inside the handle 10. The battery may be a built-in lithium ion battery, to achieve a compact design of the handheld gimbal 100.

Further, the handle 10 is further provided with a charging interface 71. In some exemplary embodiments, the charging interface 71 is disposed on a bottom portion of the handle 10, to be more easily connected to an external power supply, so as to charge the battery. In some other embodiments, the battery may alternatively be a removable and replaceable battery.

In some exemplary embodiments, the handle 10 is further provided with a microphone 72 for receiving an audio signal and an indicator 73 for displaying a battery level. There may be one indicator 73, or may be a plurality of indicators 73. In some exemplary embodiments, there is one indicator 73. A user may have audio interaction with the display screen 50 through the microphone 72, thereby further improving the experience and enjoyment of the user in interaction with the handheld gimbal 100, and meeting various user requirements. In addition, the indicator 73 may also serve as a reminder, so that the user may learn the battery level of the handheld gimbal 100 through the indicator 73 to charge the handheld gimbal 100 in time. In addition, the microphone 72 and the indicator 73 may also be both disposed on the front surface of the handle 10. This is more in line with the usage habit of users, and is easier to operate. This makes the appearance and layout of the entire handheld gimbal 100 more appropriate and aesthetic.

In some exemplary embodiments, the photographing apparatus 20 may include a gimbal support and a photographing element 22 mounted on the gimbal support. The photographing element 22 may be a camera, or may be a photographing element including a lens and an image sensor (such as a CMOS or a CCD). This can be specifically selected as needed. The photographing element 22 may be integrated to the gimbal support, and in such a case, the photographing apparatus 20 is a gimbal camera; or may be an external camera device, detachably connected to or clamped to be mounted on the gimbal support. When the photographing apparatus 20 includes the gimbal support, the control part 60 of the handle may further include a posture joystick, to control the posture of the photographing apparatus in at least one of a yaw direction, a roll direction, or a pitch direction. In some exemplary embodiments, the gimbal support is a three-axis gimbal support, and the photographing apparatus 20 is a three-axis gimbal camera. The three-axis gimbal support includes a yaw shaft assembly 23 connected to the mounting portion 27, a roll shaft assembly 24 movably connected to the yaw shaft assembly 23, and a pitch shaft assembly 25 movably connected to the roll shaft assembly 24. The photographing element 22 is mounted on the pitch shaft assembly 25. The yaw shaft assembly 23 drives the photographing apparatus 20 to rotate in the yaw direction. Certainly, in other examples, the gimbal support may alternatively be a two-axis gimbal, a four-axis gimbal, or the like. This may be specifically selected as needed. When the gimbal support is a two-axis gimbal, the gimbal support may include a roll shaft assembly and a pitch shaft assembly. The mounting portion 27 may be disposed on one end of a connecting arm connected to the roll shaft assembly. The yaw shaft assembly may be disposed in the handle. The yaw shaft assembly drives the adapter ring 15 and the photographing apparatus 20 to rotate together in the yaw direction.

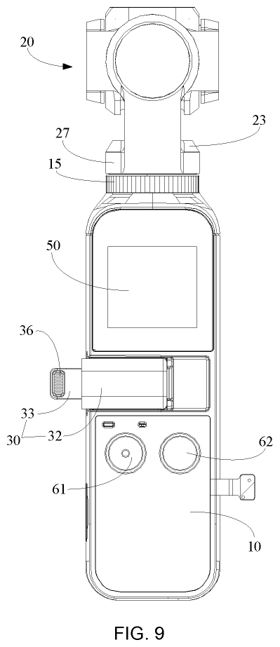

Referring to FIG. 8, in some exemplary embodiments, the handle 10 may be provided with an adapter member 30 for coupling to a mobile device 90 (such as a mobile phone), and the adapter member 30 is detachably connected to the handle 10. The adapter member 30 protrudes from a side portion of the handle to connect to the mobile device 90. After the adapter member 30 is connected to the mobile device 90, the handheld gimbal 100 is connected to the adapter member 30 to support at an end portion of the mobile device 90.

The handle 10 is provided with the adapter member 30 for connecting to the mobile device 90, then the handle 10 and the mobile device 90 are connected to each other, and the handle 10 may serve as a base of the mobile device 90, so that a user can pick up the handheld gimbal 100 by holding the other end of the mobile device 90. The connection is easy and convenient, and the product is aesthetic. In addition, after the handle 10 is coupled to the mobile device 90 through the adapter member 30, communication between the handheld gimbal 100 and the mobile device 90 may be implemented, and the photographing apparatus 20 and the mobile device 90 may transmit data to each other, thereby achieving an appropriate layout and facilitating usage.

In some exemplary embodiments, the length of the handle 10 may be shorter than the length and the width of the mobile device 90, so as to achieve a compact size. In this way, after the handheld gimbal 100 is connected to the mobile device 90 via the adapter member 30, the handle 10 may be used to support an end portion of the mobile device 90 to become a base of the mobile device 90. A user may pick up the handheld gimbal 100 by holding the other end of the mobile device 90. The connection is easy and convenient, and the product is aesthetic.

In some exemplary embodiments, the adapter member 30 may be detachably connected to the handle 10, that is, mechanical connection or detachment may be implemented between the adapter member 30 and the handle 10. Further, referring to FIG. 8, the adapter member 30 may be provided with an electrical contact portion 31, and the handle 10 is provided with an electrical contact engagement portion 12 engaged with the electrical contact portion 31.

In this case, when the handheld gimbal 100 does not need to be connected to the mobile device 90, the adapter member 30 may be detached from the handle 10. When the handheld gimbal 100 needs to be connected to the mobile device 90, the adapter member 30 is mounted on the handle 10, to complete mechanical connection between the adapter member 30 and the handle 10. In addition, the electrical connection between the adapter member 30 and the handle 10 is ensured through the connection between the electrical contact portion 31 and the electrical contact engagement portion 12, so that the photographing apparatus 20 and the mobile device 90 can transmit data to each other through the adapter member 30.

In some exemplary embodiments, a side portion of the handle 10 is provided with an accommodation slot 11, and the adapter member 30 is slidably clamped in the accommodation slot 11. After the adapter member 30 is mounted in the accommodation slot 11, the adapter member 30 partially protrudes from the accommodation slot 11, and a part of the adapter member 30 protruding from the accommodation slot 11 is used for connection to the mobile device 90.

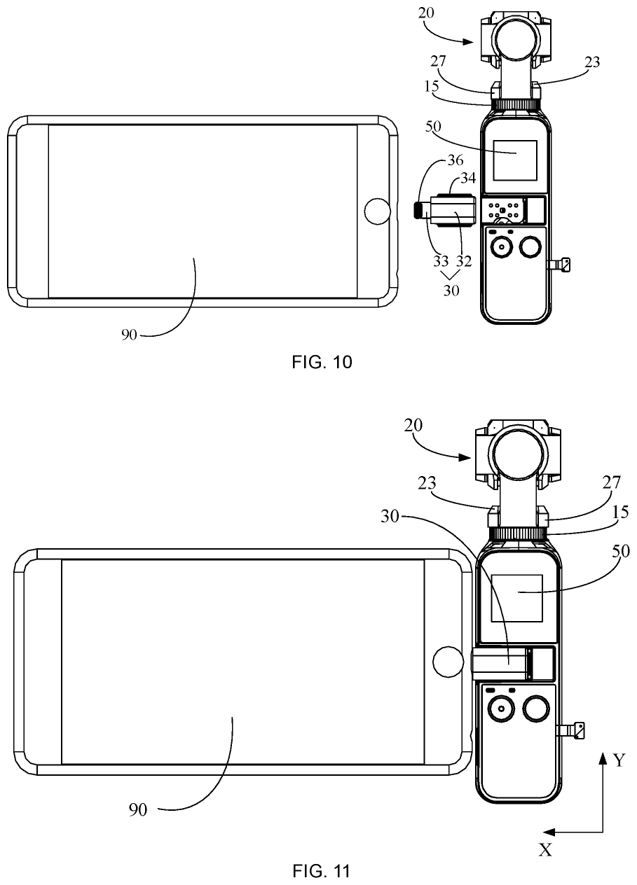

With reference to FIG. 9 and FIG. 10, in some exemplary embodiments, the adapter member 30 includes an adapter portion 32 and an adapter head 33 disposed on the adapter portion 32, and an end portion of the adapter head 33 is provided with an electrical connection portion 36 for electrically connecting to the mobile device 90. When the adapter member 30 is inserted into the accommodation slot 11 from the adapter portion 32, the adapter head 33 protrudes from the accommodation slot 11, for connecting to the mobile device 90. Referring to FIG. 11, after the mobile device 90 is connected to the adapter head 33 of the adapter member 30, the adapter head 33 is inserted into the mobile device 90, to implement a mechanical connection between the adapter member 30 and the mobile device 90. The electrical connection between the adapter member 30 and the mobile device 90 is implemented through a connection of an internal electrical contact structure between the electrical connection portion 36 and the mobile device 90.

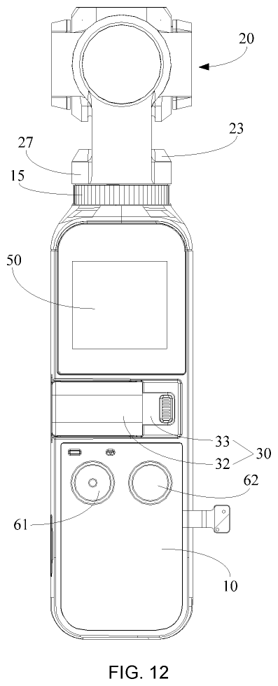

Further, referring to FIG. 12, when the adapter member 30 is inserted into the accommodation slot 11 from the adapter head 33, the adapter portion 32 is flush with the accommodation slot 11, and then the adapter member 30 is accommodated in the accommodation slot 11 of the handle 10.

Therefore, when the handheld gimbal 100 needs to be connected to the mobile device 90, the adapter member 30 may be inserted into the accommodation slot 11 from the adapter portion 32, so that the adapter head 33 protrudes from the accommodation slot 11, and the mobile device 90 and the handle 10 are connected to each other, as shown in FIG. 11. After the mobile device 90 is used, or when the mobile device 90 needs to be unplugged, the adapter member 30 may be taken out of the accommodation slot 11 of the handle 10, and then inserted into the accommodation slot 11 from the adapter head 33 in reverse, so that the adapter member 30 can be stored in the handle 10. The adapter member 30 is flush with the accommodation slot 11 of the handle 10 without affecting an appearance structure of the handle 10. In addition, storage of the adapter member 30 in the handle 10 further facilitates carrying.

In some exemplary embodiments, the accommodation slot 11 includes a first accommodation portion 111 and a second accommodation portion 112, the first accommodation portion 111 is located on an outer side of the second accommodation portion 112, and the second accommodation portion 112 matches the adapter head 33 of the adapter member 30.

When the adapter member 30 is inserted into the accommodation slot 11 from the adapter portion 32, the adapter portion 32 is located inside the first accommodation portion 111 and abuts against a side wall of the second accommodation portion 112. The adapter head 33 protrudes from the first accommodation portion 111, to facilitate connection of the mobile device 90.

When the adapter member 30 is inserted into the accommodation slot 11 from the adapter head 33, the adapter portion 32 is located inside the first accommodation portion 111 and abuts against the side wall of the second accommodation portion 112, and the adapter head 33 is located inside the second accommodation portion 112, so that the adapter member 30 is stored in the accommodation slot 11 of the handle 10.

In some exemplary embodiments, the depth of the first accommodation portion 111 matches the thickness of the adapter portion 32, so as to ensure that a surface of the adapter member 30 is flush with a surface of the handle 10 after the adapter member 30 is clamped in the accommodation slot 11. In this way, after the adapter member 30 is stored in the handle 10, it is ensured that the surface of the handle 10 is flat.

In the examples shown in the figures, the accommodation slot 11 is formed semi-open on one side surface of the handle 10, thereby making it easier for the adapter member 30 to be slidably clamped in the accommodation slot 11. Certainly, in other examples, the adapter member 30 may alternatively be detachably connected to the accommodation slot 11 of the handle 10 through a snap connection, a plug-in connection, or in other manners. When the adapter member 30 is detachably connected to the accommodation slot 11 of the handle 10 through a snap connection, a plug-in connection, or in other manners, the accommodation slot 11 may alternatively be formed in the middle of the side surface of the handle 10, so that an internal structure of the entire accommodation slot 11 can be hidden inside the handle 10, thereby making the appearance of the handle 10 more desirable.

In some exemplary embodiments, a side wall of the first accommodation portion 111 is provided with a guide groove 16 formed inwardly recessed, and a side portion of the adapter portion 32 of the adapter member 30 is provided with a guide portion 34 engaged with the guide groove 16. Through the engagement between the guide portion 34 and the guide groove 16, the adapter member 30 may be guided to be slidably clamped in the accommodation slot 11. In addition, the guide groove 16 is formed inwardly recessed from the side wall of the first accommodation portion 111, so that after the adapter member 30 is clamped in the accommodation slot 11, the guide groove 16 can further prevent the guide portion 34 from moving along a depth direction of the accommodation slot 11, thereby limiting the adapter member 30.

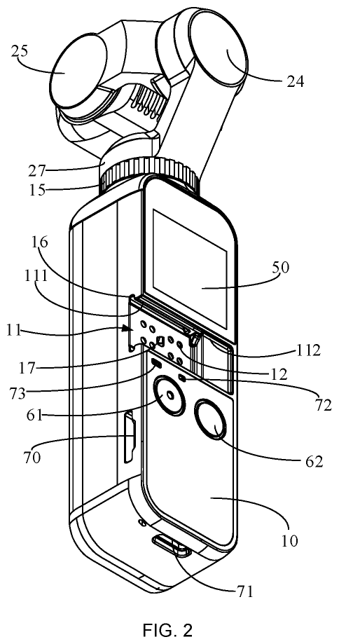

Further, with reference to FIG. 1, FIG. 2, and FIG. 8, one of the accommodation slot 11 and the adapter member 30 is provided with a positioning pin 17, and the other one of the accommodation slot 11 and the adapter member 30 is provided with a positioning slot 35 engaged with the positioning pin 17. In some exemplary embodiments, a bottom portion of the adapter portion 32 of the adapter member 30 is provided with a positioning slot 35. The positioning pin 17 may be an elastic member that can expand and contract along the depth direction of the accommodation slot 11. A bottom portion of the first accommodation portion 111 of the accommodation slot 11 may be provided with an accommodation space. The positioning pin 17 is disposed in the accommodation space. An end portion of the positioning pin 17 is of a tapered structure or a spherical structure with a slope and protrudes from a surface of the bottom portion of the first accommodation portion 111.

In this case, in a process in which the adapter member 30 is clamped in the accommodation slot 11, when the adapter member 30 comes into contact with the positioning pin 17, the part of the positioning pin 17 protruding from the surface of the bottom portion of the first accommodation portion 111 may be compressed to retract into the accommodation space. After the adapter member 30 moves in position, the position of the positioning slot 35 corresponds to that of the positioning pin 17. In this case, the positioning pin 17 extends to protrude from the surface of the bottom portion of the first accommodation portion 111 again and is clamped in the positioning slot 35, so that the adapter member 30 can be prevented from further moving along a length direction of the accommodation slot 11, thereby further providing a limiting function for the adapter member 30.

With reference to FIG. 1, FIG. 2, and FIG. 8, in some exemplary embodiments, the bottom portion of the adapter portion 32 of the adapter member 30 is provided with an electrical contact portion 31, and the bottom portion of the first accommodation portion 111 of the accommodation slot 11 is provided with an electrical contact engagement portion 12 to engage with the electrical contact portion 31.

In some exemplary embodiments, the electrical contact portion 31 may be electrically connected to the electrical contact engagement portion 12 via the contacts. For example, the electrical contact portion 31 may be selectively a telescopic probe, an electrical plug-in interface, or an electrical contact. Certainly, in other examples, the electrical contact portion 31 may be electrically connected to the electrical contact engagement portion 12 through a direct surface-to-surface contact method.

It should be noted that, in this description, relationship terms such as first and second are only used to distinguish an entity or operation from another entity or operation, but do not necessarily require or imply that there is any actual relationship or order between these entities or operations. In addition, terms “include”, “comprise”, or any other variations thereof are intended to cover non-exclusive inclusion, so that a process, a method, an article, or a device including a series of elements not only includes those elements, but also includes other elements that are not explicitly listed, or may also include inherent elements of the process, the method, the article, or the device. Without further restrictions, the elements defined by the sentence “including a . . . ” do not exclude the existence of other identical elements in the process, method, article, or device including the elements.

The foregoing describes in detail a gimbal handle and a gimbal having the same provided in some exemplary embodiments of the present disclosure. Specific examples are used herein for describing the principle and implementations of the present disclosure. The description of the foregoing embodiments is merely intended to help understand the methods of the present disclosure and core ideas thereof. In addition, a person of ordinary skill in the art can make changes to specific implementations and application scopes based on the idea of the present disclosure. Therefore, the content of this disclosure should not be construed as a limitation to the present disclosure.

What is claimed is:

1. A handheld gimbal, comprising:
a handle, including:
a first electrical contact portion, and
an adapter ring rotatably disposed on an end portion of the handle, the adapter ring including a first connecting member; and
a photographing apparatus mounted on the handle and including:
a second connecting member detachably connect to the first connecting member, and
a second electrical contact portion electrically connect to the first electrical contact portion, wherein
rotating the adapter ring in a first direction locks the first connecting member with the second connecting member, and
rotating the adapter ring in a direction opposite to the first direction unlocks the first connecting member from the second connecting member,
a mounting portion to engage with the adapter ring, and both the second connecting member and the second electrical contact portion being disposed on the mounting portion, and
wherein one of the first connecting member and the second connecting member is a clamping slot, and the other one of the first connecting member and the second connecting member is a clamping jaw adapted to the clamping slot.

2. The handheld gimbal according to claim 1, wherein the first connecting member includes a plurality of clamping slots evenly arranged on a periphery of the adapter ring, and
the second connecting member includes a plurality of clamping jaws having a quantity corresponding to a quantity of the plurality of clamping slots, and evenly arranged on a periphery of the mounting portion.

3. The handheld gimbal according to claim 1, wherein the clamping slot is formed on a top surface of the adapter ring,
the mounting portion is disposed on a bottom portion of the photographing apparatus, and
the clamping jaw is disposed on a bottom surface of the mounting portion.

4. The handheld gimbal according to claim 1, wherein the clamping jaw includes a body portion and a hook portion protruding outward from the body portion; and
the clamping slot includes a first clamping segment and a second clamping segment communicating with the first clamping segment, a radial length of the first clamping segment matching a radial length of the body portion, and a radial length of the second clamping segment being not shorter than a sum of radial lengths of the body portion and the hook portion.

5. The handheld gimbal according to claim 1, wherein the first electrical contact portion includes a plurality of first metal contacts, and
the second electrical contact portion includes a plurality of second metal contacts having a quantity corresponding to a quantity of the plurality of first metal contacts.

6. The handheld gimbal according to claim 1, wherein the handle includes a control part to control the photographing apparatus.

7. The handheld gimbal according to claim 6, wherein the control part includes at least one of
a shutter button to control photographing of the photographing apparatus,
a power button to control power on and power off of the photographing apparatus, or
a posture joystick to control a posture of the photographing apparatus.

8. The handheld gimbal according to claim 6, wherein the handle includes a card slot for inserting a storage element.

9. The handheld gimbal according to claim 8, wherein the card slot is disposed on a side surface of the handle adjacent to the control part.

10. The handheld gimbal according to claim 6, wherein a display screen is disposed on the handle to display a content photographed by the photographing apparatus, and
the display screen and the control part are arranged on a same side surface of the handle.

11. The handheld gimbal according to claim 1, wherein the photographing apparatus includes a gimbal support and a photographing element mounted on the gimbal support.

12. The handheld gimbal according to claim 11, wherein the gimbal support is a three-axis gimbal support.

13. The handheld gimbal according to claim 12, wherein the three-axis gimbal support includes:
a yaw shaft assembly movably connected to the handle,
a roll shaft assembly movably connected to the yaw shaft assembly, and
a pitch shaft assembly movably connected to the roll shaft assembly,
wherein the photographing element is mounted on the pitch shaft assembly.

14. The handheld gimbal according to claim 1, wherein an adapter member is disposed on the handle to couple with a mobile device, and
the adapter member is detachably connected to the handle.

15. The handheld gimbal according to claim 14, wherein a side portion of the handle includes an accommodation slot, and
the adapter member is slidably clamped in the accommodation slot and partially protrudes from the accommodation slot.

16. The handheld gimbal according to claim 15, wherein the adapter member includes an adapter portion and an adapter head disposed on the adapter portion; and
inserting the adapter member into the accommodation slot, at least one of the following occurs:
the adapter head protruding from the accommodation slot, or
the adapter portion being flush with the accommodation slot.

17. The handheld gimbal according to claim 16, wherein the accommodation slot includes
a second accommodation portion adapted to the adapter had, and
a first accommodation portion disposed on an outer side of the second accommodation portion;
upon inserting the adapter member into the accommodation slot from the adapter portion, the adapter portion is located inside the first accommodation portion and abuts against a side wall of the second accommodation portion, and the adapter head protrudes from the accommodation portion; and
upon inserting the adapter member into the accommodation slot from the adapter head, the adapter portion is located inside the first accommodation portion and abuts against the side wall of the second accommodation portion, and the adapter head is located inside the second accommodation portion.

18. The handheld gimbal according to claim 17, wherein an inwardly recessed guide groove is disposed on a side wall of the first accommodation portion, and
a guide portion engageable with the guide groove is disposed on a side portion of the adapter portion.

19. The handheld gimbal according to claim 15, wherein a positioning pin is disposed to one of the accommodation slot and the adapter member, and
a positioning slot engageable with the positioning pin is disposed to the other one of the accommodation slot and the adapter member.

20. The handheld gimbal according to claim 15, wherein an electrical contact portion is disposed on the adapter member, and
an electrical contact engagement portion engageable with the electrical contact portion is disposed in the accommodation slot.
